(19) United States
(12) Patent Application Publication
(10) Pub. No.: US 2016/0290125 A1
(43) Pub. Date: Oct. 6, 2016

(54) Method for Determining Drilling Fluid Induced Fractures

(71) Applicant: Schlumberger Technology Corporation, Sugar Land, TX (US)

(72) Inventors: John Rasmus, Richmond, TX (US); Tianxia Zhao, Stafford, TX (US); Thomas D. Barber, Houston, TX (US); Fernando Garcia-Osuna, Sugar Land, TX (US)

(21) Appl. No.: 14/673,598

(22) Filed: Mar. 30, 2015

(51) Int. Cl. E21B 47/12; G01V 3/18

(52) U.S. Cl. CPC E21B 47/122; G01V 3/18

(57) ABSTRACT

A tool is for use in a borehole during drilling with a drilling fluid circulating in the borehole. The tool may include a housing, a plurality of spaced apart radio frequency (RF) transmitters carried by the housing, spaced apart RF receivers carried by the housing, and a controller to communicate with the plurality of transmitters and the receivers. The controller may, at a given depth within the borehole, determine attenuation resistivity measurements and phase-shift resistivity measurements both corresponding to different radial distances from the borehole. The controller may also determine when a fracture has occurred in the geological formation at the given depth allowing the drilling fluid to intrude into the geological formation based upon the attenuation resistivity measurements and the phase-shift resistivity measurements.

### BACKGROUND

Oil-based mud (OBM) is a drilling fluid commonly used in hydrocarbon well drilling. OBM generally includes an oil base and water, along with other additives such as emulsifiers, wetting agents, and gellants, for example. While OBM is relatively expensive to use in drilling operations, the cost may be outweighed by its advantages when used in certain geological formations, particularly shale. Such advantages may include a higher drilling rate and lower torque/drag on the drill pipe, or a more stable borehole through shale intervals, for example.

Shale is normally considered to be a fracture barrier to OBM during hydraulic stimulation. However, in some instances mud chemistry may weaken the shale, and thus contribute to the shale failure. A bottom hole pressure (BHP) surge effect while running the drill in the borehole or circulating pressures while drilling or reaming may exacerbate or contribute to a drill-induced fracture. Such a fracture may be extended with further surge pressures until a lost-circulation zone is created, in which large volumes of OBM escapes from the borehole into the formation. This may result in several days of lost drilling time, including time trying to identify the interval or location where the fracture, and thus the lost OBM circulation, occurred.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A tool may be for use in a borehole during drilling with a drilling fluid circulating in the borehole such as OBM. The downhole tool may include a housing, a plurality of spaced apart radio frequency (RF) transmitters carried by the housing, a plurality of spaced apart RF receivers carried by the housing, and a controller to communicate with the plurality of transmitters and the plurality of receivers. The controller may, at a given depth within the borehole, determine a plurality of attenuation resistivity measurements and phase-shift resistivity measurements both corresponding to different radial distances from the borehole. The controller may also determine when a fracture has occurred in the geological formation at the given depth allowing the drilling fluid to intrude into the geological formation based upon the plurality of attenuation resistivity measurements and the plurality of phase-shift resistivity measurements.

A related method for using a tool, such as the one described briefly above, is also provided. The method may include, at a given depth within the borehole, determining a plurality of attenuation resistivity measurements and phase-shift resistivity measurements corresponding to different radial distances from the borehole. The method may further include determining when a fracture has occurred in the geological formation at the given depth allowing the drilling fluid to intrude into the geological formation based upon the plurality of attenuation resistivity measurements and the plurality of phase-shift resistivity measurements.

A related non-transitory computer-readable medium is also provided having computer executable instructions for causing a computer to at least, at a given depth within the borehole, determine a plurality of attenuation resistivity measurements and phase-shift resistivity measurements corresponding to different radial distances from the borehole using a tool, such as the one described briefly above. A determination may be made as to when a fracture has occurred in the geological formation at the given depth allowing the drilling fluid to intrude into the geological formation based upon the plurality of attenuation resistivity measurements and the plurality of phase-shift resistivity measurements.

### BRIEF DESCRIPTION OF THE DRAWINGS

FIG. 1 is a schematic diagram illustrating a wellbore logging while drilling (LWD) system in which an OBM-induced fracture detection approach may be used.

FIG. 2 is a perspective view of an LWD tool which may be used with the system of FIG. 1 in an example embodiment.

FIGS. 3 and 4 are graphs of simulated attenuation and phase-shift resistivities, respectively, for the LWD tool of FIG. 2 over an OBM-induced fracture width range.

FIGS. 5 and 6 are graphs of simulated attenuation and phase resistivities, respectively, for the LWD tool of FIG. 2 similar to those of FIGS. 3 and 4 but for a shallower fracture.

FIG. 7 is a flow diagram illustrating method aspects for OBM-induced fracture detection in accordance with an example embodiment.

FIG. 8 is a graph showing different phase and attenuation depths of investigation for a 2 MHz operating frequency in accordance with an example embodiment.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Generally speaking, an approach is set forth herein to identify borehole fractures that result in lost drilling fluid (e.g., oil-based mud, OBM, or mud) circulation during drilling based upon LWD measurements. The approach may be particularly advantageous in low resistivity regions of a geological formation, in that a contrast between the induced fracture with OBM therein and the formation may be such that there is distinct signature difference from other potential problems that may occur during the drilling process.

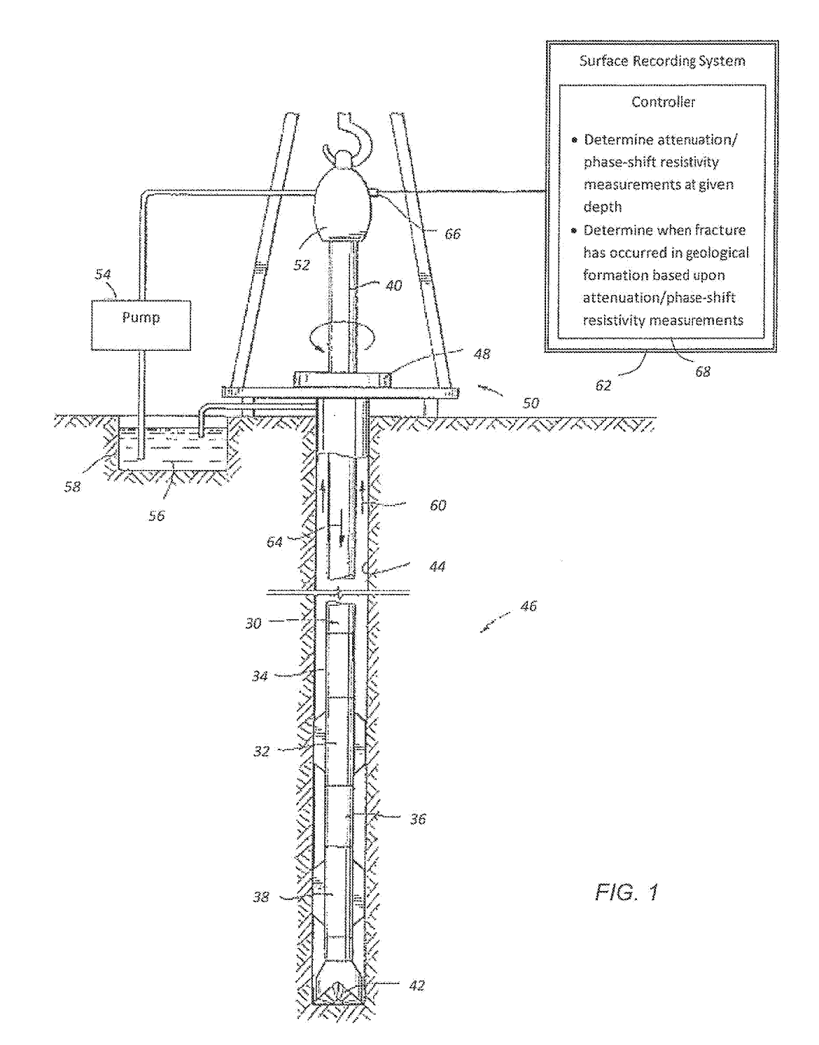

Referring now to FIG. 1, an example approach for a well-logging application, such as for hydrocarbon resource (e.g., oil, natural gas, etc.) wells, is first described. The example shown in FIG. 1 is for a logging while drilling (LWD) or measurement while drilling (MWD) implementation. In the illustrated embodiment, an example configuration for acquiring well log data using an LWD/MWD system 30 is shown. The LWD/MWD system 30 illustratively includes one or more collar sections 32, 34, 36, 38 coupled to the lower end of a drill pipe 40. The LWD/MWD system 30 includes a drill bit 42 at the bottom end to drill the wellbore or borehole 44 through the earth or geological formation 46. In this example, drilling is performed by rotating the drill pipe 40 using a rotary table 48. However, drilling may also be performed by other suitable approaches, such as top drives and coiled tubing drilling with downhole motors, for example.

During rotation, the pipe 40 is suspended by equipment on a drill rig 50 including a swivel 52, which enables the pipe 40 to rotate while maintaining a fluid tight seal between the interior and exterior of the pipe 40. Mud pumps 54 draw drilling fluid, such as OBM or simply “mud”, 56 from a tank or pit 58 and pump the OBM through the interior of the pipe 40, down through the LWD/MWD system 30, as indicated by arrow 64. The mud 56 passes through orifices (not shown) in the bit 42 to lubricate and cool the bit 42, and to lift drill cuttings in through an annulus 60 between the pipe 40 and the wellbore 44.

The collar sections 32, 34, 36, 38 may include sensors (not shown) therein which make measurements of various properties of the geological formation 46 through which the wellbore 44 is drilled. These measurements may be recorded in a recording device disposed in one or more of the collar sections 32, 34, 36, 38, or communicated to a surface recording system 62 outside of the well illustratively including a controller 68. For example, MWD systems may also provide the telemetry (communication system) for any MWD/LWD tool sensors in the drill string. By way of example, the controller 62 may be implemented using a combination of hardware (e.g., microprocessor, etc.), and a non-transitory computer-readable medium having computer executable instructions for performing the various operations noted herein.

Example LWD systems include one or more sensors which measure formation properties such as density, resistivity, gamma rays, porosity, etc., as will be described further below. Other sensors may also be included to measure selected drilling parameters, such as inclination and azimuth trajectory of the wellbore 44, for example. Additional drilling sensors may include a sensor for measuring axial force (weight) applied to the LWD/MWD system 30, and shock and vibration sensors.

The LWD/MWD system 30 may further include a mud pressure modulator (not shown separately) in one of the collar sections (e.g., the collar section 34). The modulator applies a telemetry signal to the flow of mud 56 inside the system 30 and pipe 40 where the telemetry signal is detected by a pressure sensor 66 disposed in the mud flow system. The pressure sensor 66 is coupled to detection equipment in a surface recording system 62, which enables recovery and recording of information transmitted in the telemetry scheme sent by the MWD portion of the LWD/MWD system 30. The telemetry scheme may include a subset of measurements made by the various sensors in the LWD/MWD system 30. The telemetry of the logging tools may also be determined using a wireline cable, or electrical MWD telemetry (e.g., using electrical signals transmitted through the formation). Measurements made by the various sensors in the LWD/MWD system 30 may also be transferred to the surface recording system 62 when the LWD/MWD system 30 is withdrawn from the wellbore.

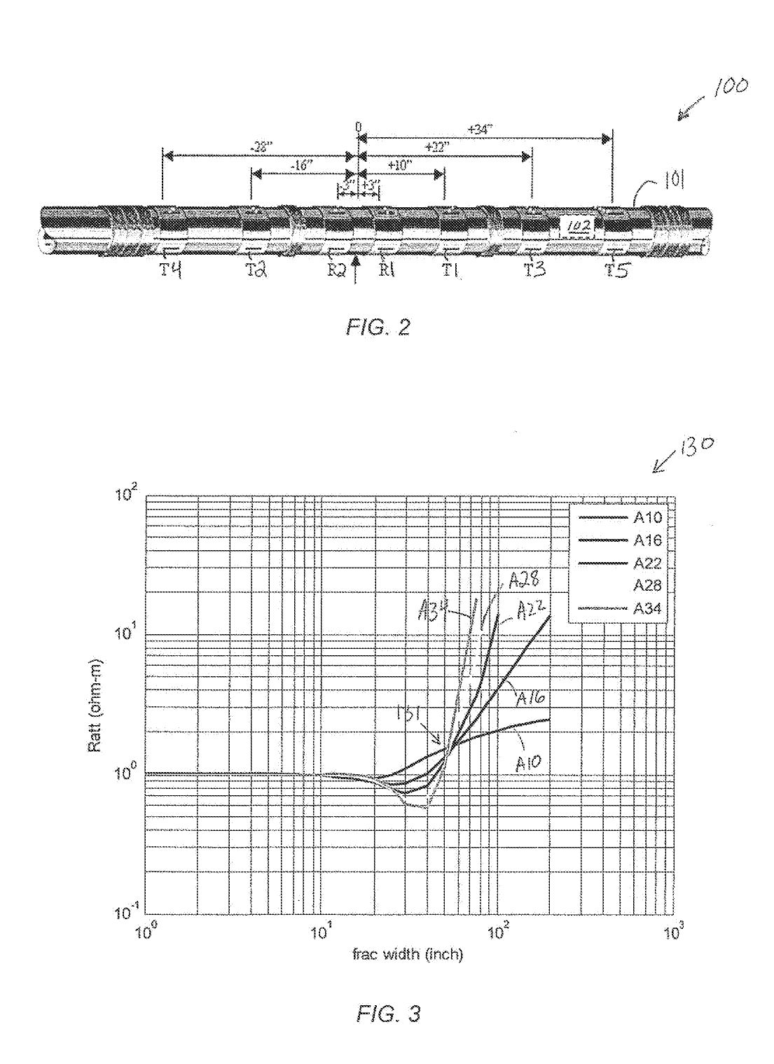

Turning now to FIG. 2, one such LWD tool which may be included in the tool string shown in FIG. 1 is a resistivity measurement tool 100. With respect to resistivity measurements, when the magnetic dipole moment of both the transmitter(s) and receivers is along a common tool axis, this is sometimes referred to as ZZ coupling, or co-axial measurements. The resistivity measurement tool 100 has such a configuration, in which a plurality of radio frequency (RF) transmitters T1-T5 and a plurality of RF receivers R1 and R2 are spaced apart as shown along a cylindrical housing 101. The resistivity measurement tool 100 further illustratively includes a controller 102, which may control the RF transmitters T1-T5 and RF receivers R1, R2 for performing resistivity measurements. The controller 102 may also communicate with the surface recording system 62, e.g., via telemetry, as noted above.

In the illustrated configuration, the receivers R1, R2 are directly adjacent, but spaced apart from, one another near the center of the housing 101. More particularly, an example spacing of six inches is provided between the receivers R1 and R2. The transmitters T1-T5 are arranged such that the odd numbered transmitters (i.e., T1, T3, and T5) are on one side of the receivers R1, R2 (namely the right side in FIG. 2), while the even numbered transmitters (T2 and T4) are on the opposite side of the receivers (the left side in the illustrated embodiment). Moreover, the transmitters T1-T5 are located at progressively larger distances from the midpoint between the receivers R1, R2, namely ten inches for transmitter T1, sixteen inches for transmitter T2, twenty-two inches for transmitter T3, twenty-eight inches for transmitter T4, and thirty-four inches for transmitter T5. It should be noted that the transmitter/receiver locations and spacings discussed above are provided as one example embodiment, but other numbers and positions of transmitters and receivers may be used in different embodiments.

Furthermore, for the example implementations set forth herein, the resistivity measurement tool 100 operates at two frequencies, namely 400 kHz and 2 MHz. As will be understood by those skilled in the art, different combinations of transmitters and RF frequencies may be used to investigate resistivity characteristics at different radial distances from the borehole. In an example implementation, twenty measurement channels (attenuation and phase shift for five spacing and two frequencies) are provided, though other channel configurations may be used in different embodiments. Also, the tool 100 illustrated in FIG. 2 is intended for a collar size of 4.75″, although other sizes of collars, and other operating frequencies and channel configurations, may also be used.

By way of example, the techniques described herein for OBM-induced fracture detection may be implemented in a resistivity tool such as a compensated dual resistivity (CDR) or array resistivity compensated (ARC) tool from the present Applicant Schlumberger Limited, although these techniques may generally be implemented in other resistivity measurement tools as well that provide coaxial (ZZ coupling) measurements for logging while drilling due to fractures. The techniques described herein may advantageously provide for real-time monitoring while drilling to identify the interval or depth at which lost OBM circulation has occurred. Generally speaking, an OBM fracture pattern may be defined in three dimensions, including a height measured along the borehole axis, a radial length or distance the fracture pattern extends from the borehole 44 into the geological formation 46, and an angular width or aperture of the fracture pattern.

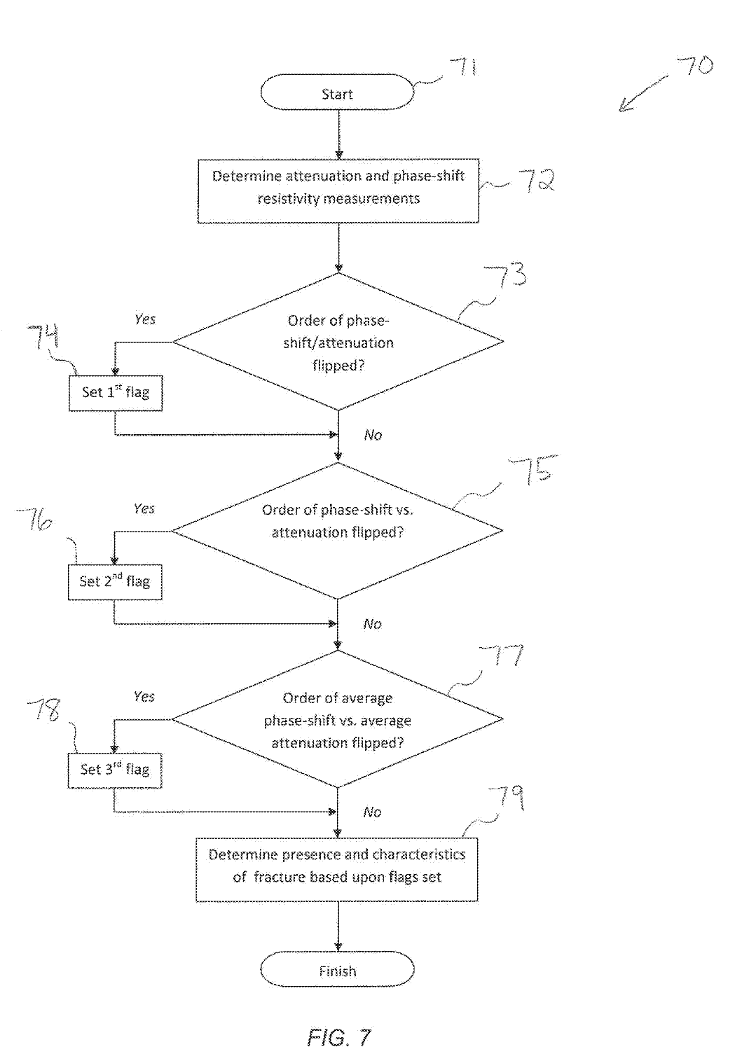

Beginning at Block 71 of the flow diagram 70 of FIG. 7, at a given depth within the borehole 44, a plurality of attenuation resistivity measurements and phase-shift resistivity measurements are both determined corresponding to different radial distances from the borehole, at Block 72. More particularly, these measurements may be taken at an initial time (t₁) to provide a set of baseline measurements for time-lapse investigation of the borehole 44 to determine the formation of OBM-induced fractures over a period of time. By way of example, the measurements may be taken by “firing” one or more of the transmitters T1-T5 in a sequence, such as successive 0.1s signal bursts from each of the transmitters. The first and second receivers R1, R2 receive the signal that has been attenuated and phase shifted by the geological formation 46, and the attenuation and phase-shift resistivity measurements may be determined accordingly.

In the example of FIG. 7, Rₐₜₜₙ₁ is an attenuation resistivity at a first radial distance from the borehole 44, Rₐₜₜₙ₂ is an attenuation resistivity at a second radial distance farther from the borehole than the first radial distance, Rₚₛ₁ is a phase-shift resistivity at the first radial distance, and Rₚₛ₂ is a phase-shift resistivity at the second radial distance. Based upon the attenuation and phase-shift resistivity measurements taken at the given depth of the borehole 44, an initial determination may be made as to whether a potential fracture is likely to have occurred at this location or not, at Block 73. If not, the process illustratively concludes at Block 74 for the given depth, but the process described herein may be repeated at other depths along the borehole 44 as drilling progresses, and even repeated at the given depth at a later time by raising the drill 42 and tool string, or pausing at the given depth, if desired. By way of example, the first distance may be a closest measured radial distance to the borehole, while the second distance may be an intermediate radial distance or even the maximum radial distance measured by the resistivity measurement tool 100, depending upon the given implementation.

Making a determination that a potential fracture has occurred may be useful in that, if taken at a single instant or if taken when the fracture is just beginning, the signature of a fluid-induced fracture may be confused with other effects, e.g., resistive invasion, conductive shoulder effect, or anisotropy. However, such effects may be excluded or disproven based upon other lithology sensitive measurements to identify the presence of shale to disprove the possibility of invasion, well trajectory and layering to disprove the presence of a nearby layer boundary in the case of high angle/horizontal wells, and well inclination to disprove the presence of an anisotropic response in vertical wells or subsequent (e.g., time-lapse) measurements, for example.

The controller 102 may communicate resistivity measurement data to the surface recording system 62 so that the controller 68 may use the measurements to determine if the conditions in equation (1), and thus a potential OBM-induced fracture, are present. However, it should be noted that in some embodiments, the controller 102 may evaluate the resistivity measurement data on-board the resistivity measurement tool 100, and not transmit the measured resistivity data (or just transmit certain portions of the data) uphole, which may useful in applications where telemetry bandwidth is at a premium, for example.

Where a potential fracture has been determined at the given depth, further measurements may be taken at a later time (or over a period of time), at Block 75, to determine if or when an actual fracture has occurred, and the extent of the fracture. It may be useful to determine when an OBM-induced fracture has occurred in the geological formation 46 at a given depth, as such a fracture will allow OBM 56 to intrude into the geological formation 46. This may be costly not just in terms of lost drilling time, but also lost OBM. The controller 68 (or controller 102, in some embodiments) may make a determination that, based upon measured attenuation and phase-shift resistivity measurements, a fracture has indeed occurred (as opposed to one of the other above-noted conditions such as anisotropy, etc.), along with an estimated radial length of the fracture, as will be discussed further below. The controller 68 (or 102) may determine the attenuation resistivity measurements and the phase-shift resistivity measurements based upon a ratio of signals received by the plurality of receivers, as will be appreciated by those skilled in the art. Generally speaking, fracture determination may be used upon an order of the phase-shift and attenuation resistivity measurements, the order of the phase-shift resistivity measurements relative to the attenuation resistivity measurements, and an order of the average of phase-shift resistivity measurements relative to an order of the average attenuation resistivity values.

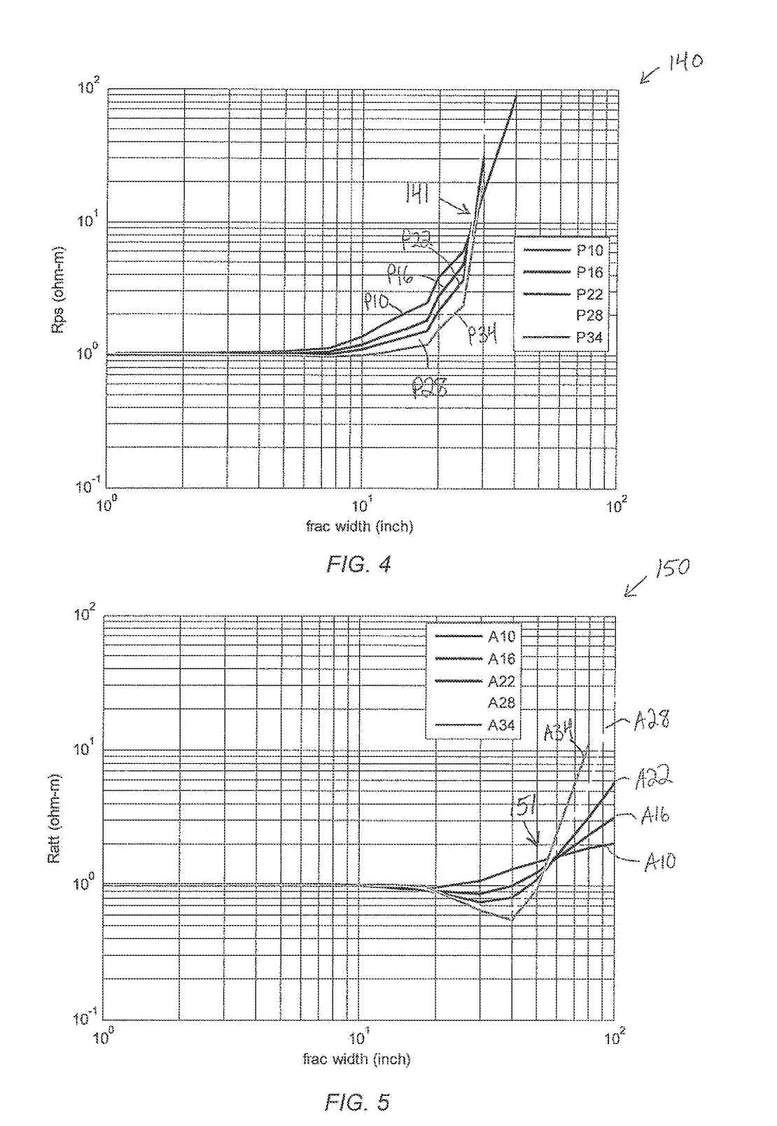

The foregoing will be further understood with reference to FIGS. 3-6. These figures show the results of simulated phase-shift measurement and attenuation measurements for the five different transmitter T1-T5 spaced locations described above. The above-noted equations (1)-(3) are used to recognize the distinct signature patterns which occur with attenuation resistivity and phase-shift resistivity measurements versus fracture width. More particularly, as the width of the fracture increases and more OBM penetrates the formation 46, the attenuation resistivity measurements change from Rₐₜₜₙ₂<Rₐₜₜₙ₁ to Rₐₜₜₙ₁ <Rₐₜₜₙ₂. The phase-shift resistivity measurements also experience a similar change, but the point of change for fracture width is different in that for phase-shift resistivity it changes later than for attenuation resistivity. Throughout the increase in fracture width, the attenuation resistivity will remain less than the corresponding phase-shift resistivity.

The graph 130 of FIG. 3 shows simulated resistivity attenuation vs. fracture width. In the illustrated example, the plot line A10 corresponds to the attenuation resistivity measurements from the transmitter T1, the plot line A16 corresponds to the attenuation resistivity measurements from the transmitter T2, the plot line A22 corresponds to the attenuation resistivity measurements from the transmitter T3, the plot line A28 corresponds to the attenuation resistivity measurements from the transmitter T4, and the plot line A34 corresponds to the attenuation resistivity measurements from the transmitter T5. For this example, the model parameters are for a fracture 5 m in length and 0.04 m thick, and the width of the fracture radius varies as shown on the X-axis of the graph 130, and the measurements were based upon a 2 MHz operating frequency for the transmitters T1-T5. As noted above, the attenuation resistivity measurements “flip” at a point 131 where the (radially) close resistivity measurements become greater than the far resistivity measurements.

The graph 140 of FIG. 4 shows the corresponding phase resistivity measurements for the configuration described with respect to FIG. 3. The plot line P10 corresponds to the phase-shift resistivity measurements from the transmitter T1, the plot line P16 corresponds to the phase-shift resistivity measurements from the transmitter T2, the plot line P22 corresponds to the phase-shift resistivity measurements from to the transmitter T3, the plot line P28 corresponds to the phase-shift resistivity measurements from the transmitter T4, and the plot line P34 corresponds to the phase-shift resistivity measurements from the transmitter T5. Here again, it will be seen that at a point 141 the phase-shift resistivity values flip, as noted above.

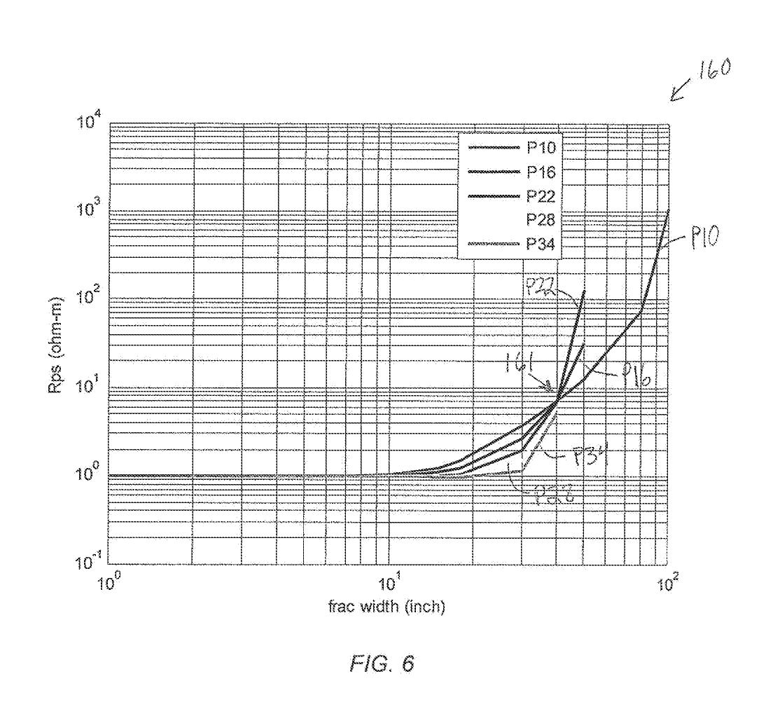

The graphs 150 and 160 of FIGS. 5 and 6 are respectively similar to the graphs 130 and 140 of FIGS. 3 and 4, with the exception that the graphs 150 and 160 are for a fracture length that is a quarter of the fracture length used in the simulation of FIGS. 3 and 4. Here again, it will be seen that the attenuation resistivity plots A10, A16, A22, A28, and A34 invert or flip at a point 151, while the phase-shift resistivity plots P10, P16, P22, P28, and P34 invert or flip at a point 161. It should be noted that simulations at different angular rotations within the borehole 44 established that similar signatures shown in FIGS. 3-6 may be observed irrespective of the angular position of the fracture in the borehole sidewall with respect to the transmitter orientation.

As noted above, for shallow or relatively small fractures, the measured effect may be very similar to resistive invasion or conductive shoulder effects. However, OBM fracture-induced invasion is most likely to occur in porous and permeable formations, which may be determined by considering other measurements such as natural gamma-ray, neutron-density porosities, background resistivity values, or spectroscopy measurements, for example. Conductive shoulder or adjacent bed effects may be determined (and conversely, excluded) by considering other factors such as well inclination and bedding dip using programs such as 3DP in conjunction with forward modeling to determine if these effects are present. Thus, such other information may be used to determine if a conductive shoulder or resistive invasion effects are possible, in which case time-lapse measurements using the resistivity measurement tool 100 need not be used. That is, when used in conjunction with such other information, an initial series of resistivity measurements may be sufficient to determine the existence of a fracture using the relationships discussed with respect to FIG. 7 above.

It should also be noted that 400 KHz (or other frequency) measurements may also be used in conjunction with the 2 MHz measurements (or alone in some configurations). Measurements based upon a 400KHz frequency are radially deeper reading and are generally unresponsive to shallow OBM filled fractures. As the fracture radius increases, the 400 KHz measurements begin to be affected in the same manner as the 2 MHz measurements. As such, the combination of measurements at different frequencies may be used to enhance accuracy of the fracture determination in some configurations.

An example logic flow for determining drilling induced fractures (DIF) in accordance with an example embodiment is now described with reference to the flow diagram 70 of FIG. 7. The logic flow may be used with either of 2 MHz data or 400 KHz data, as discussed above, as well as with other desired operating frequencies. Radial lengths of the fractures into the formation may be determined and categorized as shallow, medium and deep, for example. Generally speaking, the logic may search for certain conditions based upon the measured attenuation and phase-shift resistivity values, and set a respective flag when one of these conditions occurs. Based upon the flags that are set, a determination as to the existence and nature of the fracture may be ascertained.

Beginning at Block 71, phase-shift and attenuation resistivity measurements are taken at a given depth within the borehole 44, which may be done at a single time or as time-lapse measurements. A first condition that may trigger setting of a flag is the order of the phase shift and attenuation measurements, at Block 73, and more particularly when an order of at least some of the phase-shift or attenuation measurements flips or reverses order (e.g., the closest measurements to the borehole become larger than those far away, which may be indicative of OMB penetration from the borehole 44. Based upon the occurrence of this condition, a first level spacing order flag may be set, at Block 74. In the code that follows below, DS means deep to shallow with respect to resistivity order, i.e., the deepest reading measurement reads the lowest resistivity and the shallowest reading measurement reads the higher resistivity. For example, if P22H (phase-shift measurement associated with transmitter T3 in FIG. 2) lower than P16H (phase-shift measurement associated with transmitter T2 in FIG. 2), then a first level flag for a DS condition is set. On the other hand, the nomenclature SD is the opposite case. This logic may be applied to both phase and attenuation measurements separately. A number flag may be set corresponding to the total number of conditions satisfied.

A second flag condition may correspond to an order of a phase measurement with respect to its corresponding attenuation measurement having the same spacing, at Block 75. For example, if the phase vs. attenuation order for P16H vs. A16H (attenuation measurement associated with transmitter T2 in FIG. 2) changes, then a second level flag may be set, at Block 76.

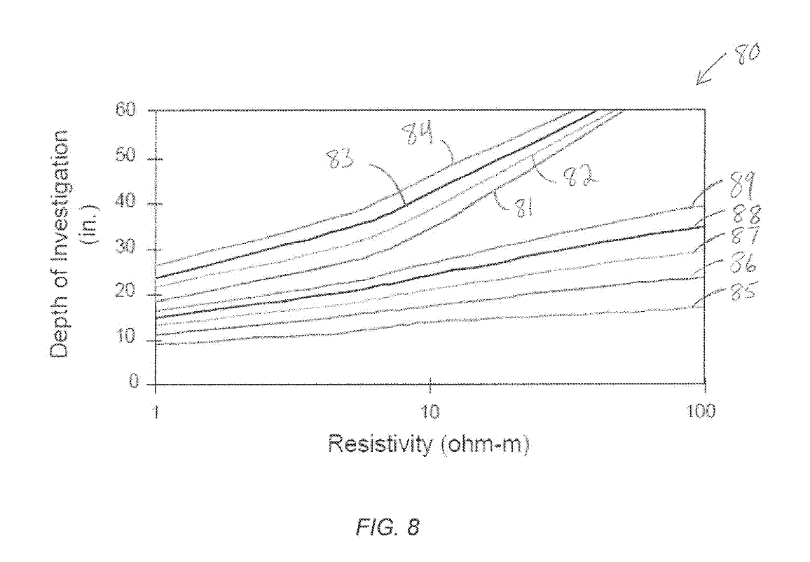

Similarly, another condition which may trigger a flag is when an order of the average phase-shift vs. average attenuation resistivity values changes or flips, at Block 77. When this occurs, a third level flag may be set, at Block 78. From a combination of the flag values, the presence and type (e.g., shallow, medium, or large radial length, etc.) of DIF may be determined, at Block 79, which concludes the example method illustrated in FIG. 7 (Block 80). FIG. 8 is a graph 80 showing different phase and attenuation depths of investigation for 2 MHz frequency operation, which represents the relative shape and radial geometrical factors for propagation measurements in general (the resulting shapes for 400 KHz are similar). In the graph 80, the plot lines 81, 82, 83, and 84 respectively correspond to the attenuation resistivity measurements associated with the transmitters T2, T3, T4, and T5 of FIG. 2. Furthermore, the plot lines 85, 86, 87, 88, and 89 respectively correspond to the attenuation resistivity measurements associated with the transmitters T1 T2, T3, T4, and T5.

The following is an example Python script which may be used for implementing the approach described above with respect to FIG. 7.

```
# spacing order flags
      #2MHz phase computations
      sum_ph2_spacing_order_ds_flag=0
      sum_ph2_spacing_order_sd_flag=0
      if p16h > PH2_Threshold*p22h:
sum_ph2_spacing_order_ds_flag=sum_ph2_spacing_order_ds_flag+1
      if p22h > PH2_Threshold*p28h:
sum_ph2_spacing_order_ds_flag=sum_ph2_spacing_order_ds_flag+1
      if p28h > PH2_Threshold*p34h:
sum_ph2_spacing_order_ds_flag=sum_ph2_spacing_order_ds_flag+1
      if p34h > PH2_Threshold*p40h:
sum_ph2_spacing_order_ds_flag=sum_ph2_spacing_order_ds_flag+1
      if PH2_Threshold*p16h < p22h:
sum_ph2_spacing_order_sd_flag=sum_ph2_spacing_order_sd_flag+1
      if PH2_Threshold*p22h < p28h:
sum_ph2_spacing_order_sd_flag=sum_ph2_spacing_order_sd_flag+1
      if PH2_Threshold*p28h < p34h:
sum_ph2_spacing_order_sd_flag=sum_ph2_spacing_order_sd_flag+1
      if PH2_Threshold*p34h < p40h:
sum_ph2_spacing_order_sd_flag=sum_ph2_spacing_order_sd_flag+1
      ph2_spacing_order_sd_flag=sum_ph2_spacing_order_sd_flag
      ph2_spacing_order_ds_flag=sum_ph2_spacing_order_ds_flag
      #2MHz attenuation computations
      sum_att2_spacing_order_ds_flag=0
      sum_att2_spacing_order_sd_flag=0
      if a16h > ATT2_Threshold*a22h:
sum_att2_spacing_order_ds_flag=sum_att2_spacing_order_ds_flag+1
      if a22h > ATT2_Threshold*a28h:
sum_att2_spacing_order_ds_flag=sum_att2_spacing_order_ds_flag+1
      if a28h > ATT2_Threshold*a34h:
sum_att2_spacing_order_ds_flag=sum_att2_spacing_order_ds_flag+1
      if a34h > ATT2_Threshold*a40h:
sum_att2_spacing_order_ds_flag=sum_att2_spacing_order_ds_flag+1
      if ATT2_Threshold*a16h < a22h:
sum_att2_spacing_order_sd_flag=sum_att2_spacing_order_sd_flag+1
      if ATT2_Threshold*a22h < a28h:
sum_att2_spacing_order_sd_flag=sum_att2_spacing_order_sd_flag+1
      if ATT2_Threshold*a28h < a34h:
sum_att2_spacing_order_sd_flag=sum_att2_spacing_order_sd_flag+1
      if ATT2_Threshold*a34h < a40h:
sum_att2_spacing_order_sd_flag=sum_att2_spacing_order_sd_flag+1
      att2_spacing_order_sd_flag=sum_att2_spacing_order_sd_flag
      att2_spacing_order_ds_flag=sum_att2_spacing_order_ds_flag
# phase vs attenuation order flags
      sum_pa2_order_ds_flag=0
      sum_pa2_order_sd_flag=0
      if PA2_Threshold*a16h < p16h: sum_pa2_order_ds_flag=sum_pa2_order_ds_flag+1
      if PA2_Threshold*a22h < p22h: sum_pa2_order_ds_flag=sum_pa2_order_ds_flag+1
      if PA2_Threshold*a28h < p28h: sum_pa2_order_ds_flag=sum_pa2_order_ds_flag+1
      if PA2_Threshold*a34h < p34h: sum_pa2_order_ds_flag=sum_pa2_order_ds_flag+1
      if PA2_Threshold*a40h < p40h: sum_pa2_order_ds_flag=sum_pa2_order_ds_flag+1
      if a16h > PA2_Threshold*p16h: sum_pa2_order_sd_flag=sum_pa2_order_sd_flag+1
      if a22h > PA2_Threshold*p22h: sum_pa2_order_sd_flag=sum_pa2_order_sd_flag+1
      if a28h > PA2_Threshold*p28h: sum_pa2_order_sd_flag=sum_pa2_order_sd_flag+1
      if a34h > PA2_Threshold*p34h: sum_pa2_order_sd_flag=sum_pa2_order_sd_flag+1
      if a40h > PA2_Threshold*p40h: sum_pa2_order_sd_flag=sum_pa2_order_sd_flag+1
      pa2_order_ds_flag=sum_pa2_order_ds_flag
      pa2_order_sd_flag=sum_pa2_order_sd_flag
# avg phase vs avg attenuation order flag
      resistivity2_sd_flag=0
      resistivity2_ds_flag=0
      phase2_avg=(p16h+p22h+p28h+p34h+p40h)/5
      atten2_avg=(a16h+a22h+a28h+a34h+a40h)/5
      if PA2_Threshold*phase2_avg < atten2_avg : resistivity2_sd_flag=1
      if phase2_avg > PA2_Threshold*atten2_avg : resistivity2_ds_flag=1
# compute effects flags
      # Deep to shallow conditions
      # Phase2 DS flag
      if ph2_spacing_order_ds_flag>Phase2_Spacing_Order_Threshold:
        if gr>=gr_cutoff:
            if MUD_TYPE == “OBM”:
                  sum_dif2_shallow_flag=sum_dif2_shallow_flag+1
      # attn2 DS flag
      if att2_spacing_order_ds_flag>Attn2_Spacing_Order_Threshold:
        if gr>=gr_cutoff:
            if MUD_TYPE == “OBM”:
                  sum_dif2_shallow_flag=sum_dif2_shallow_flag+1
                  sum_dif2_intermediate_flag=sum_dif2_intermediate_flag+1
      # resistivity phase vs attenuation DS flag
      if pa2_order_ds_flag>2:
        if gr>=gr_cutoff:
            if MUD_TYPE == “OBM”:
                  sum_dif2_shallow_flag=sum_dif2_shallow_flag+1
                  sum_dif2_intermediate_flag=sum_dif2_intermediate_flag+1
                  sum_dif2_deep_flag=sum_dif2_deep_flag+1
      # avg phase vs avg attenuation DS flag
      if resistivity2_ds_flag>0:
        if gr>=gr_cutoff:
            if MUD_TYPE == “OBM”:
                  sum_dif2_shallow_flag=sum_dif2_shallow_flag+1
                  sum_dif2_intermediate_flag=sum_dif2_intermediate_flag+1
                  sum_dif2_deep_flag=sum_dif2_deep_flag+1
      # shallow to deep conditions
      # Phase2 SD flag
      if ph2_spacing_order_sd_flag>Phase2_Spacing_Order_Threshold:
        if gr>=gr_cutoff:
            if MUD_TYPE == “OBM”:
                  sum_dif2_intermediate_flag=sum_dif2_intermediate_flag+1
                  sum_dif2_deep_flag=sum_dif2_deep_flag+1
      # attn2 SD flag
      if att2_spacing_order_sd_flag>Attn2_Spacing_Order_Threshold:
        if gr>=gr_cutoff:
            if MUD_TYPE == “OBM”:
                  sum_dif2_deep_flag=sum_dif2_deep_flag+1
# outputs
      dif2_shallow_flag=sum_dif2_shallow_flag
      dif2_intermediate_flag=sum_dif2_intermediate_flag
      dif2_deep_flag=sum_dif2_deep_flag
```

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A tool for use in a borehole during drilling with a drilling fluid circulating in the borehole, the tool comprising:
a housing;
a plurality of spaced apart radio frequency (RF) transmitters carried by said housing;
a plurality of spaced apart RF receivers carried by said housing; and
a controller to communicate with said plurality of transmitters and said plurality of receivers to
at a given depth within the borehole, determine a plurality of attenuation resistivity measurements and phase-shift resistivity measurements both corresponding to different radial distances from the borehole, and
determine when a fracture has occurred in the geological formation at the given depth allowing the drilling fluid to intrude into the geological formation based upon the plurality of attenuation resistivity measurements and the plurality of phase-shift resistivity measurements.

2. The tool of claim 1 wherein said controller determines a potential fracture at the given depth at a first time, and determines that the fracture has occurred at a second time after the first time.

3. The tool of claim 1 wherein said controller determines the potential fracture based upon an order of magnitudes of the plurality of attenuation resistivity measurements over the different radial distances from the borehole, and an order of magnitudes of the plurality of phase-shift resistivity measurements over the different radial distances from the borehole.

4. The tool of claim 1 wherein said controller determines the potential fracture based upon an order of magnitudes of the plurality of attenuation resistivity measurements over the different radial distances from the borehole with respect to an order of magnitudes of the plurality of phase-shift resistivity measurements over the different radial distances from the borehole.

5. The tool of claim 1 wherein said controller determines the potential fracture based upon averages of the plurality of attenuation resistivity measurements with respect to averages of the plurality of phase-shift resistivity measurements over the different radial distances from the borehole.

6. The tool of claim 1 wherein said controller determines the plurality of attenuation resistivity measurements and the plurality of phase-shift resistivity measurements based upon a ratio of signals received by said plurality of receivers.

7. The tool of claim 1 wherein said controller determines when a fracture has occurred further based upon a reference measurement for the geological formation.

8. The downhole tool of claim 7 wherein the reference measurement comprises at least one of a gamma-ray measurement, neutron-density measurement, background resistivity measurement, and a spectroscopy measurement.

9. The tool of claim 1 wherein said controller is remotely located from the housing outside of the borehole.

10. The tool of claim 1 wherein said controller is carried by said housing.

11. The tool of claim 1 wherein said controller determines when a fracture has occurred in the geological formation at the given depth allowing the drilling fluid to intrude into the geological formation based upon a response of the attenuation resistivity measurements and a response of the phase-shift resistivity measurements.

12. A method for using a tool in a borehole during drilling with a drilling fluid circulating in the borehole, the tool comprising a plurality of spaced apart radio frequency (RF) transmitters and a plurality of spaced apart RF receivers, the method comprising:
at a given depth within the borehole, determining a plurality of attenuation resistivity measurements and phase-shift resistivity measurements both corresponding to different radial distances from the borehole; and
determining when a fracture has occurred in the geological formation at the given depth allowing the drilling fluid to intrude into the geological formation based upon the plurality of attenuation resistivity measurements and the plurality of phase-shift resistivity measurements.

13. The method of claim 11 further comprising determining a potential fracture at the given depth at a first time, and wherein determining the fracture has occurred comprises determining the fracture has occurred at a second time after the first time.

14. The method of claim 11 wherein determining when the fracture has occurred comprises determining when the fracture has occurred based upon an order of magnitudes of the plurality of attenuation resistivity measurements over the different radial distances from the borehole, and an order of magnitudes of the plurality of phase-shift resistivity measurements over the different radial distances from the borehole.

15. The method of claim 11 wherein determining when the fracture has occurred comprises determining when the fracture has occurred based upon an order of magnitudes of the plurality of attenuation resistivity measurements over the different radial distances from the borehole with respect to an order of magnitudes of the plurality of phase-shift resistivity measurements over the different radial distances from the borehole.

16. The method of claim 11 wherein determining when the fracture has occurred comprises determining when the fracture has occurred based upon averages of the plurality of attenuation resistivity measurements with respect to averages of the plurality of phase-shift resistivity measurements over the different radial distances from the borehole.

17. The method of claim 11 wherein determining the plurality of attenuation resistivity measurements and the plurality of phase-shift resistivity measurements comprises determining the plurality of attenuation resistivity measurements and the plurality of phase-shift resistivity measurements based upon a ratio of signals received by the plurality of receivers.

18. The method of claim 11 wherein determining when a fracture has occurred further comprises determining when a fracture has occurred also based upon a reference measurement for the geological formation comprising at least one of a gamma-ray measurement, neutron-density measurement, background resistivity measurement, and a spectroscopy measurement.

19. A non-transitory computer-readable medium having computer executable instruction for causing a computer to at least:
for a tool in a borehole during drilling with a drilling fluid circulating in the borehole, the tool comprising a plurality of spaced apart radio frequency (RF) transmitters and a plurality of spaced apart RF receivers, at a given depth within the borehole, determine a plurality of attenuation resistivity measurements and phase-shift resistivity measurements both corresponding to different radial distances from the borehole; and
determine when a fracture has occurred in the geological formation at the given depth allowing the drilling fluid to intrude into the geological formation based upon the plurality of attenuation resistivity measurements and the plurality of phase-shift resistivity measurements.

20. The non-transitory computer-readable medium of claim 19 further having computer-executable instructions for causing the computer to determine a potential fracture at the given depth at a first time; and wherein the fracture is determined to have occurred at a second time after the first time.

21. The non-transitory computer-readable medium of claim 19 wherein a determination of when the fracture has occurred is based upon an order of magnitudes of the plurality of attenuation resistivity measurements over the different radial distances from the borehole, and an order of magnitudes of the plurality of phase-shift resistivity measurements over the different radial distances from the borehole.

22. The non-transitory computer-readable medium of claim 19 wherein a determination of when the fracture has occurred is based upon an order of magnitudes of the plurality of attenuation resistivity measurements over the different radial distances from the borehole with respect to an order of magnitudes of the plurality of phase-shift resistivity measurements over the different radial distances from the borehole.

23. The non-transitory computer-readable medium of claim 19 wherein a determination of when the fracture has occurred is based upon averages of the plurality of attenuation resistivity measurements with respect to averages of the plurality of phase-shift resistivity measurements over the different radial distances from the borehole.
